(19) United States
(12) Patent Application Publication
(10) Pub. No.: US 2016/0344483 A1
(43) Pub. Date: Nov. 24, 2016

(54) Antenna Calibration in Communications

(71) Applicant: Nokia Solutions and Networks Oy, Espoo (FI)

(72) Inventors: Jukka KAREISTO, Kempele (FI); Eero Olavi HEIKKINEN, Oulu (FI)

(73) Assignee: Nokia Solutions and Networks Oy, Espoo (FI)

(21) Appl. No.: 15/110,772

(22) PCT Filed: Jan. 15, 2014
(86) PCT No.: PCT/EP2014/050641

§ 371 Date: Jul. 11, 2016

(51) Int. Cl. H04B 17/12; H04B 1/04

(52) U.S. Cl. CPC H04B 17/12; H04B 1/0475; H04B 2001/0425; H04W 84/042

(57) ABSTRACT

A method is disclosed for antenna calibration in communications, the method co icing creating an uplink calibration signal for active antenna or antenna array uplink calibration, at a baseband part of a transmitter directly to a selected duplex spacing or another specified spacing from a transmission signal inside a baseband output sampling rate spectrum of the transmitter. Measurements are carried out on the uplink calibration signal. Based on collected measurement data, calibration information is calculated. The active antenna or antenna array uplink calibration is performed based on the calculated calibration information.

### FIELD OF THE INVENTION

The exemplary and non-limiting embodiments of this invention relate generally to wireless communications networks, and more particularly to antenna calibration.

### BACKGROUND ART

The following description of background art may include insights, discoveries, understandings or disclosures, or associations together with dis-closures not known to the relevant art prior to the present invention but provided by the invention. Some such contributions of the invention may be specifically pointed out below, whereas other such contributions of the invention will be apparent from their context.

Wideband communication systems, such as LTE systems, have a significantly wider bandwidth than in previous wireless systems. The LTE system supports the application of multiple antenna techniques, e.g. MIMO and beam forming. A beam forming algorithm normally assumes that an antenna array has no errors and that its multi-channel transceiver has an identical transfer function for each transceiver chain. However, due to mechanical and electrical variations in the radio frequency components such as amplifiers, mixers and cables, the spatial signature of a baseband receive/transmit signal may be different from an actual radio frequency receive/transmit signal. As a result, transfer functions of the radio frequency transceivers may differ from each other, i.e. amplitude, time and phase deviations may appear between different antenna branches. Thus, it is important to perform antenna calibration to compensate the deviations between the different antenna branches to achieve an expected antenna gain.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise a method, an apparatus, a computer program product, a computer-readable storage medium, a transmitter and a network element as defined in the independent claims. Further embodiments of the invention are disclosed in the dependent claims.

An aspect of the invention relates to a method for antenna calibration in communications, the method comprising creating an uplink calibration signal for active antenna or antenna array uplink calibration, at a baseband part of a transmitter directly to a selected duplex spacing or another specified spacing from a transmission signal inside a baseband output sampling rate spectrum of the transmitter; carrying out measurements on the uplink calibration signal; based on collected measurement data, calculating calibration information; and performing the active antenna or antenna array uplink calibration based on the calculated calibration information.

A further aspect of the invention relates to an apparatus comprising an arrangement for coupling an antenna, and a transmitter operationally coupled to the antenna, wherein the transmitter is configured to create an uplink calibration signal for active antenna or antenna array uplink calibration, at a baseband part of a transmitter directly to a selected duplex spacing or another specified spacing from a transmission signal inside a transmitter baseband branch sampling rate spectrum to a digital-to-analogue converter of the transmitter; carry out measurements on the uplink calibration signal; based on collected measurement data, calculate calibration information; and perform the active antenna or antenna array uplink calibration based on the calculated calibration information.

A still further aspect of the invention relates to a computer program product comprising program code means configured to perform any of the method steps when the program is run on a computer.

A still further aspect of the invention relates to a computer-readable storage medium comprising program code means configured to perform any of the method steps when executed on a computer.

A still further aspect of the invention relates to a transmitter comprising said apparatus.

A still further aspect of the invention relates to a network element comprising said transmitter.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of exemplary embodiments with reference to the attached drawings, in which

FIG. 1a illustrates an exemplary antenna calibration structure according to an embodiment;

FIG. 1b illustrates an exemplary antenna calibration structure according to an embodiment;

FIG. 2 illustrates an existing antenna calibration structure;

FIG. 3 illustrates an embedded uplink calibration structure according to a first exemplary embodiment of the invention;

FIG. 4 illustrates an embedded uplink calibration structure according to a second exemplary embodiment of the invention;

FIG. 5 shows a simplified block diagram illustrating exemplary system architecture;

FIG. 6 shows a simplified block diagram illustrating exemplary apparatuses;

FIG. 7 shows a schematic diagram of a flow chart according to an exemplary embodiment of the invention.

### DETAILED DESCRIPTION OF SOME EMBODIMENTS

An exemplary embodiment enables simplifying the structure needed for active antenna arrays calibration, and improves the calibration signal and base station (BTS) Tx traffic performance during run time calibration. A goal at the active antenna calibration is that it is possible to run the calibration during normal BTS traffic with least possible effects for the BTS traffic.

An existing structure is using a single transmitter (Tx) branch to generate needed uplink (UL) calibration transmission. This technique is blocking one Tx branch power out of the BTS traffic during the time when the calibration is running. After the calibration is done, the Tx branch needs to be taken back in normal BTS use and a power amplifier (PA) needs to run linearization what makes a calibration process and Tx transmission linearization more complicated to manage.

In an exemplary embodiment, an embedded uplink signaling method enables running the active antenna uplink calibration without any effects for the Tx branches used for the BTS traffic, and also enables avoiding an extra need for PA linearization after the run time uplink calibration.

In an exemplary embodiment, at a certain frequency inside the Tx branch BB sampling rate spectrum used, an output spectrum generated separated uplink calibration signal spectrum makes it possible to run the active antenna calibration fully at the same time with the normal BTS Tx traffic without any effect to the normal Tx traffic.

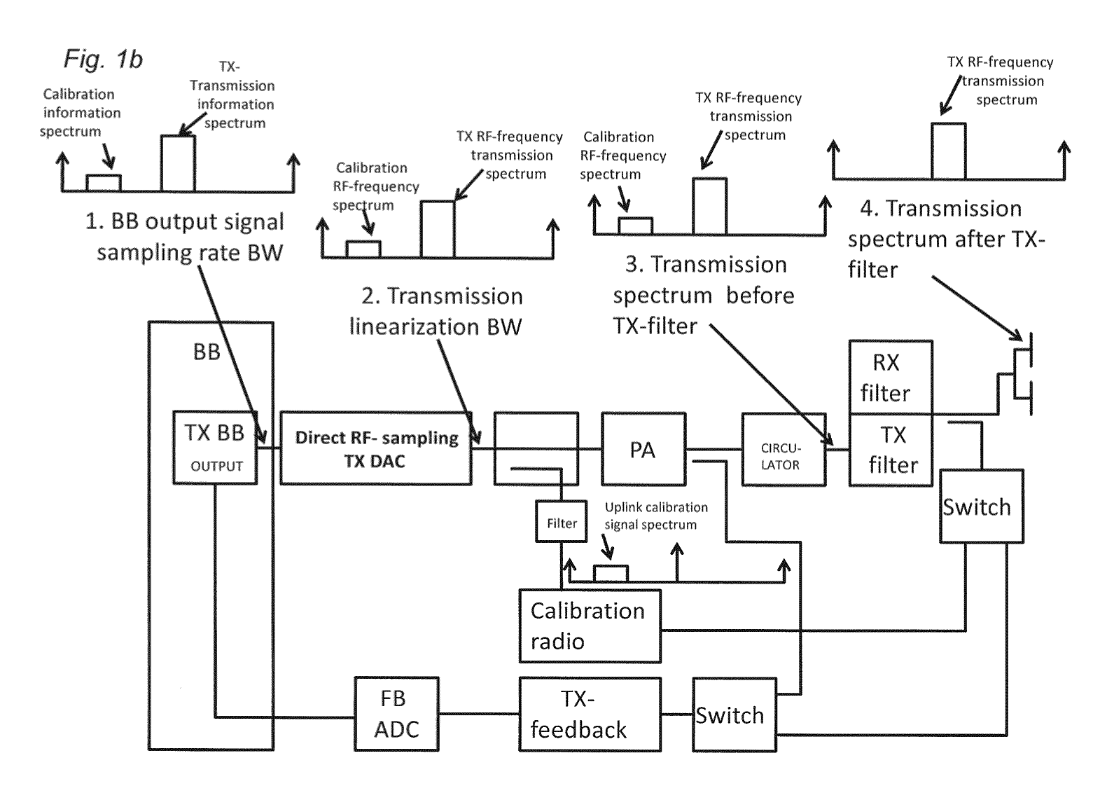

In existing structures for the active antenna system beam calibration, the uplink calibration signal is generated by using a baseband (BB) and one Tx branch modulator. A calibration code is generated for the BB processing and modulated to the Tx frequency at the Tx modulator part. Because the generated calibration transmission is created at the Tx frequency, it is not allowed to send it on the air with full Tx power. For this reason, the calibration signal that is modulated to the Tx frequency, is taken via a radio frequency (RF) switch to the calibration radio mixer and the RF switch isolates the calibration signal from the PA amplifier. A disadvantage of this is that one Tx branch transmission is interrupted during the uplink calibration is running and one PA capacity is not in use. Because the PA amplifier is switched ON and OFF, it also makes the PA linearization and the calibration signaling processing more complicated to manage. The existing structure for the uplink calibration is based on one Tx branch reference power, and a failure in this particular Tx branch terminates the active module calibration process. The existing structure is illustrated in FIG. 2.

An exemplary embodiment discloses an embedded uplink calibration method and apparatus for the active antenna beam calibration. An exemplary embodiment discloses an uplink calibration signaling method and apparatus for the active antenna beam calibration between separate antennas and antenna arrays. An exemplary structure makes it possible to run the uplink calibration without any interruption period for the normal BTS traffic because of the run time active antenna calibration.

An exemplary embodiment enables performing the active antennas and antenna arrays uplink calibration without any transmission interruption by using a simplified structure with fewer components and a higher accuracy. An exemplary embodiment enables creating the calibration signal at the BB part to a correct duplex spacing, amplitude and information directly to a specified spacing from the Tx transmission signal inside a BB sampling rate output signal spectrum to the Tx digital-to-analogue converter (DAC). After a Tx modulator mixer, or direct RF sampling structures without the mixer, the required uplink calibration signal and the original Tx transmission signal are both present at the Tx DAC or, depending on the implementation, Tx mixer output spectrum. The Tx transmission traffic signal is at the correct frequency and the calibration signal is also separated from the Tx transmission with a required separation. The separation may be directly the used Tx to receiver (Rx) duplex separation or another specified separation.

Because the uplink calibration signal is now having its own spectrum separated from the Tx transmission spectrum, the uplink calibration spectrum may be read out from the Tx modulator mixer output or the direct RF sampling Tx DAC output by using a directional coupler or an RF probe. Because the Tx traffic signal and the uplink calibration signals are now having separated spectrums, the calibration code does not pass to the PA amplifier at the Tx frequency. The uplink calibration signal passes to PA amplifier, but the signal is out of a Tx pass band and does not pass a front end Tx filter.

In an exemplary embodiment, the BB Tx output signal sampling rate bandwidth (BW) to a Tx digital-to-analogue converter (DAC) and PA linearization bandwidth need to be wide enough so that both cover the required Tx transmission and uplink calibration signals frequency separation. To avoid a feature that BB DPD PA linearization rejects the calibration signal during PA linearization, the calibration signal needs to pass Tx pre-distortion band filtering. At a Tx feedback point of view, because the Tx transmission and calibration signals may be read out at a Tx feedback radio, a PA linearization unit DPD keeps the calibration signal instead of rejecting it from the created spectrum. This technique enables creating the calibration signal inside the Tx pre-distortion band without losing the signal at the linearization. Depending on the configuration, it is also possible to terminate PA DPD linearization during the uplink calibration and use linearization information already known at that time. The calibration signal level used is also created at a level low enough at BB so that after PA located at the front end Tx filter the Rx rejection ensures that the calibration signal does not pass on the air. The uplink calibration signal may also be taken, depending on the case, from one or each Tx branch used by using cheap/cost effective directional couplers or RF probes. Because the calibration may now be taken from each Tx branch, this structure also improves a reliability of the system.

It is possible to cancel PA DPD linearization during the period of the uplink calibration using previous linearization information. This technique also uses the BB modulated uplink calibration signal. In this technique, Tx feedback or DPD is not involved in the uplink calibration signal staying in the system, because the linearization is temporally not in use.

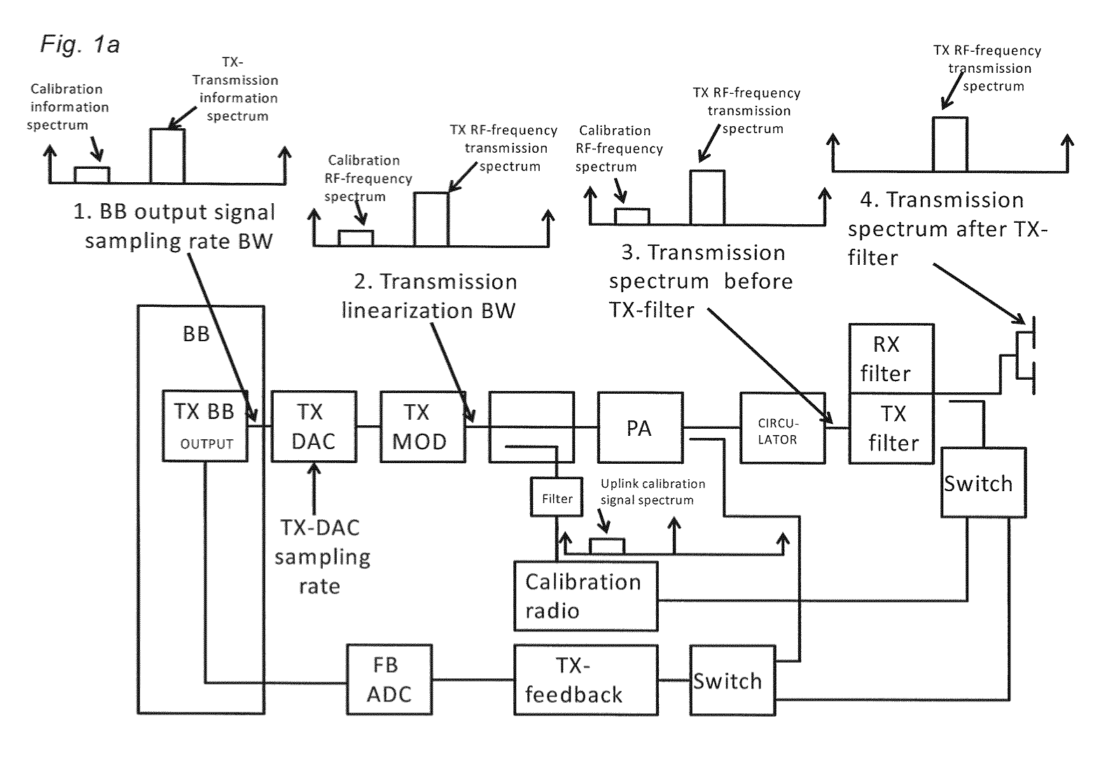

In an exemplary embedded uplink calibration it is possible to use combinations with and without the mixer. In an exemplary structure with the mixer, the transmission does not need to be interrupted during the time the uplink calibration is running. In an exemplary structure without the mixer, the structure is more cost effective and it enables providing higher phase accuracy. Different types of mixers generate a phase error between UL and downlink (DL) calibration chains, and the embedded uplink calibration without the mixer improves calibration chain phase performance. The embedded uplink calibration signal generation is illustrated in FIG. 1a and FIG. 1b.

Differences between an exemplary embedded uplink calibration and the existing structure with the isolating switch between Tx PA is illustrated in FIGS. 2, 3 and 4.

In the existing structure illustrated in FIG. 2, the Tx signal is taken after the Tx modulator by using the RF switch. The RF switch is isolating so that the Tx signal modulated with the calibration code does not pass the antenna with the full RF power. The Tx signal from the switch is transformed to the correct UL band by using the mixer.

A disadvantage is that during uplink calibration time one Tx branch traffic is cancelled during the time the calibration is running. With the existing structure, this means that one Tx branch power is cancelled during each time the RF pipe uplink calibration used is running.

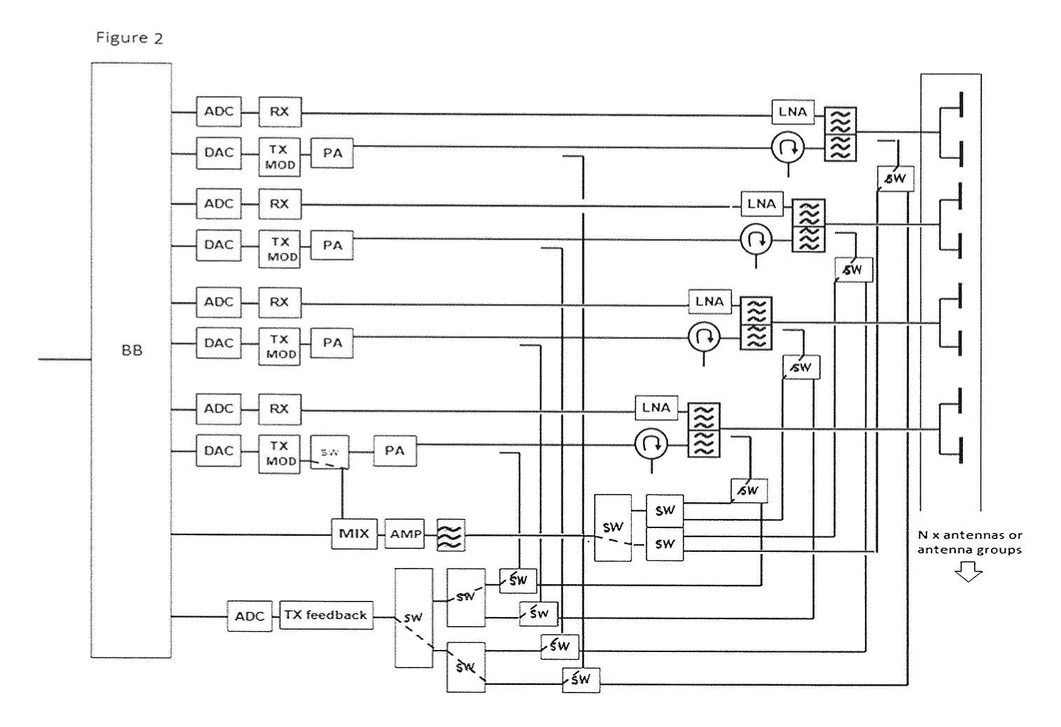

In an exemplary embedded uplink calibration structure illustrated in FIG. 3, the active antenna uplink calibration signal is generated to the required spacing from the Tx transmission signal at the BB part. The Tx transmission is operatively used at the same time the uplink calibration signal is read out by using the directional coupler. An exemplary implementation with the mixer enables using the required separation between the Tx transmission and the uplink calibration signal. For example, if the BB Tx branch sampling rate BW is not supporting enough bandwidth for the direct Tx to Rx duplex separation, the mixer may be used to shift the output frequency exactly to the required frequency.

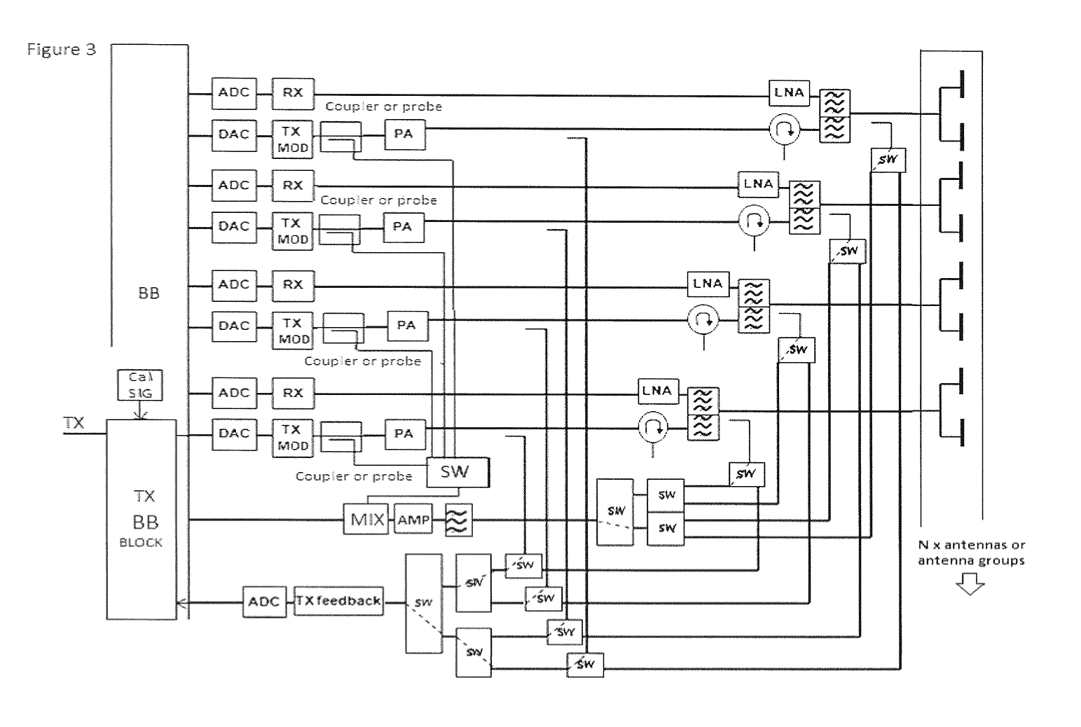

In another exemplary embedded uplink calibration implementation illustrated in FIG. 4, the active antenna uplink calibration signal and the Tx transmission are generated directly to the required Tx to Rx duplex spacing at the BB part. The Tx transmission is operatively used at the same time the uplink calibration signal is read out by using the directional coupler. An exemplary implementation without the mixer makes the structure more cost effective and also simplifies the required hardware (HW) design. This structure also improves the active antenna calibration phase accuracy, because the Tx and Rx chains calibration branches do not include two mixers. The mixers are generating a phase error, and the overall system phase error is easier to manage when the calibration loop only includes one mixer.

FIG. 1a is an illustration how the uplink calibration spectrum is added to the BB output signal spectrum together with the required transmission signal, and finally how the Tx transmission signal and the calibration signal are separated to the correct RF branches.

FIG. 1b illustrates a direct RF sampling Tx DAC structure without the modulator and mixer block. DAC is directly sampling the uplink calibration signal and the traffic signal to the correct RF frequency.

FIG. 2 illustrates an existing calibration structure where the Tx frequency modulated calibration is taken by using the switch from the Tx signal branch. During the uplink calibration time, the traffic of one Tx chain is interrupted.

FIG. 3 illustrates an embedded uplink calibration structure according to a first exemplary embodiment. The calibration signal is generated at the BB module directly inside the Tx output sample rate spectrum with the required frequency separation. In the first exemplary embodiment, to transform the generated calibration signal to the correct uplink RF frequency, the mixer is used.

FIG. 4 illustrates an embedded uplink calibration structure according to a second exemplary embodiment. The calibration signal is generated at the BB module directly inside the Tx output sample rate spectrum with the required Tx and Rx frequency duplex separation. In the second exemplary embodiment, the calibration signal is directly at the correct uplink RF frequency and may be used at the calibration.

An exemplary embodiment may be used e.g. for active antenna or antenna arrays integrated calibration signal generation, traditional BTS or active antenna or antenna arrays Rx chain self-diagnostics, active antenna or antenna arrays out of Tx band integrated signal monitoring, active antenna or antenna arrays out of the Tx band signal generation, active antenna or antenna arrays Tx filter bypassing for a generated signal or signals, and/or active antenna or antenna arrays internal diagnostics signal generation.

In an exemplary embodiment, the active antenna or antenna arrays uplink calibration may be performed by using its own Tx branch without any interruption to the normal BTS Tx traffic. The required uplink calibration spectrum is created inside the BB Tx output signal sampling spectrum. Thus, exemplary embedded uplink calibration method and apparatus enable avoiding disturbance to normal BTS traffic.

Thus, an exemplary embedded uplink calibration technique enables running the uplink calibration without the Tx transmission being interrupted. This type of calibration at the active antenna products enables avoiding unnecessary and complicated Tx interruption during the active antenna uplink calibration.

Exemplary embodiments of the present invention will now be de-scribed more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any network element, user terminal, server, corresponding component, and/or to any communication sys-tem or any combination of different communication systems that support antenna calibration. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

Tx may be a transmitter such as the one in a base station or in a user equipment. A multiplier may combine signal parts and feed the combined signal to an amplifier unit. The amplifier unit passes the signal to be transmit-ted towards an antenna.

A coupler may be coupled between the amplifier unit and the antenna. The coupler may sample a part of a radio frequency signal traveling between the amplifier unit and the antenna for a converter. After the converter the signal may be amplified and filtered. A coupler may be a directional coupler used to couple a part of a signal traveling in the direction from an amplifier unit towards the antenna and/or a part of a signal reflected from the antenna or from a connector of the antenna traveling in the direction from the antenna towards the amplifier unit. The directional coupler is coupling in one direction and is isolated to the other direction. The direction of the coupler may be changed by turning the directional coupler and isolated lines to an opposite way. The coupler may also be a dual directional coupler. An RF probe that is bi-directional, may also be used. The RF probe is not directionally isolated and it couples similarly in both ways.

A measuring unit may receive a radio frequency signal and measure a strength of the radio frequency signal. The strength may be measured as a power or as an absolute amplitude. The analog DC signal can be transformed to a digital format by an analogue-to-digital converter. The amplifier may include a power amplifier PA which amplifies the signal to be transmitted. A power supply to the power amplifier may be a parameter to be controlled and hence the power amplifier may obtain its operational voltage from a power supply unit, which may be controllable.

In the following, different embodiments will be described using, as an example of a system architecture whereto the embodiments may be applied, an architecture based on LTE/LTE-A network elements, without restricting the embodiment to such an architecture, however. The embodiments de-scribed in these examples are not limited to the LTE/LTE-A radio systems but can also be implemented in other radio systems, such as UMTS (universal mobile telecommunications system), GSM, EDGE, WCDMA, bluetooth net-work, WLAN or other fixed, mobile or wireless network. In an embodiment, the presented solution may be applied between elements belonging to different but compatible systems such as LTE and UMTS.

The transmitter may include many components that have component-level dynamic and static phase, amplitude and delay variations. An exemplary active antenna system (AAS) is able to measure and correct the impact of the component variations.

The exemplary AAS system may have a beam-forming and calibration functionality, independent transmitter/receiver modules.

In an exemplary embodiment, within transmitter modules there may be components to inject and detect the calibration signal. The calibration signals may be generated in a common calibration function. In addition to normal signal paths, HW components for the calibration apparatus may include: a probe/coupler which inject and isolate calibration signal from main traffic signal; a switch system to route an isolated calibration signal to a pre-distortion feedback receiver; a converter to convert calibration signal to a right RF channel and switch the signal to the probe/coupler; and a calibration function that may be done by using a processor, FPGA fabric, ASIC, or a combination of those. An exemplary implementation is a processor-FPGA combination which may also have other functions such as beam-forming.

Mathematically, the calibration signal may be a kind of signal that is not correlating with a normal BTS traffic signal but is having good features for the calibration measurements. Suitable coding may include, for example, a WCDMA gold code, a Walsh code, a Kazakh code, and a pseudo random noise code, as well.

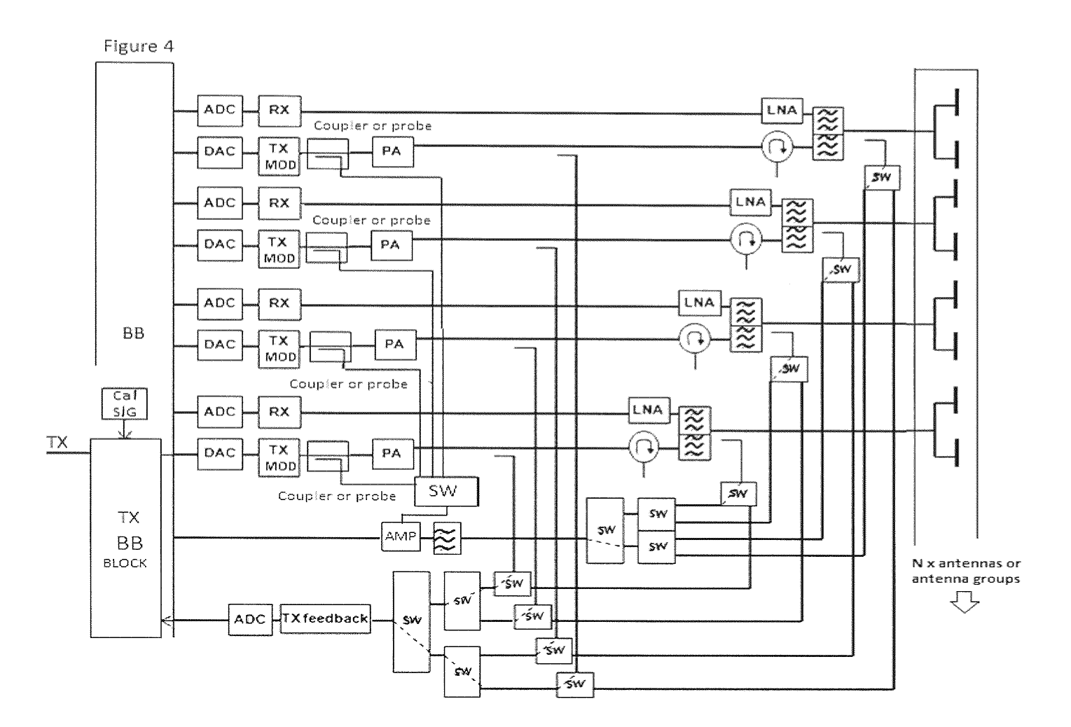

A general architecture of a communication system is illustrated in FIG. 5. FIG. 5 is a simplified system architecture only showing some elements and functional entities, all being logical units whose implementation may differ from what is shown. The connections shown in FIG. 5 are logical connections; the actual physical connections may be different. It is apparent to a person skilled in the art that the systems also comprise other functions and structures. It should be appreciated that the functions, structures, elements and the protocols used in or for active antenna array beam calibration, are irrelevant to the actual invention. Therefore, they need not to be discussed in more detail here.

The exemplary radio system of FIG. 5 comprises a network node 501 of a network operator. The network node 501 may include e.g. an LTE base station of a macro cell (eNB), radio network controller (RNC), or any oth-er network element, or a combination of network elements. The network node 501 may be connected to one or more core network (CN) elements (not shown in FIG. 5) such as a mobile switching centre (MSC), MSC server (MSS), mo-bility management entity (MME), gateway GPRS support node (GGSN), serv-ing GPRS support node (SGSN), home location register (HLR), home subscriber server (HSS), visitor location register (VLR). In FIG. 5, the radio net-work node 501 that may also be called eNB (enhanced node-B, evolved node-B) or network apparatus of the radio system, hosts the functions for radio resource management in a public land mobile network.

FIG. 5 shows one or more user equipment 502 located in the ser-vice area of the radio network node 501. The user equipment refers to a porta-ble computing device, and it may also be referred to as a user terminal. Such computing devices include wireless mobile communication devices operating with or without a subscriber identification module (SIM) in hardware or in soft-ware, including, but not limited to, the following types of devices: mobile phone, smart-phone, personal digital assistant (PDA), handset, laptop computer. In the example situation of FIG. 5, the user equipment 502 is capable of connecting to the radio network node 501 via a (cellular radio) connection 503.

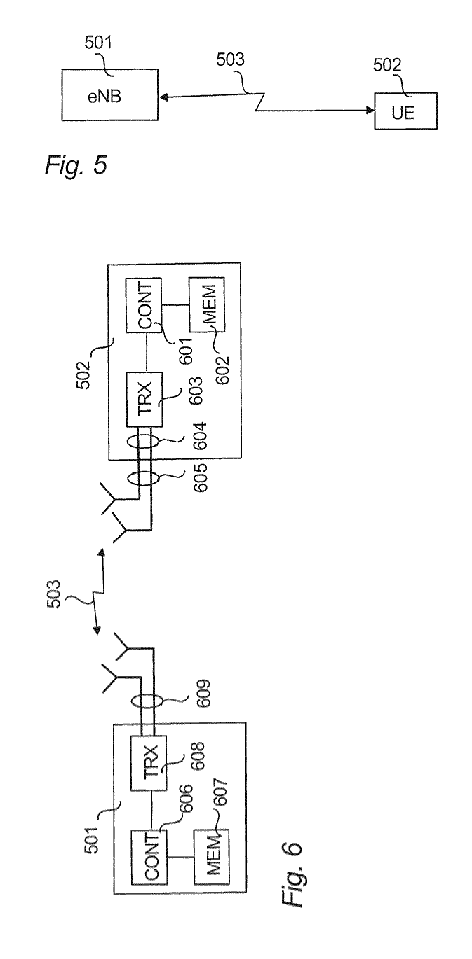

FIG. 6 is a block diagram of an apparatus according to an embodiment of the invention. FIG. 6 shows a user equipment 502 located in the area of a radio network node 501. The user equipment 502 is configured to be in connection 503 with the radio network node 501. The user equipment or UE 502 comprises a controller 601 operationally connected to a memory 602 and a transceiver 603. The controller 601 controls the operation of the user equipment 502. The memory 602 is configured to store software and data. The transceiver 603 is configured to set up and maintain a wireless connection 503 to the radio network node 501, respectively. The transceiver 603 is operationally connected to a set of antenna ports 604 connected to an antenna arrangement 605. The antenna arrangement 605 may comprise a set of antennas. The number of antennas may be one to four, for example. The number of antennas is not limited to any particular number. The user equipment 502 may also comprise various other components, such as a user interface, camera, and media player. They are not displayed in the figure due to simplicity.

The radio network node 501, such as an LTE (or LTE-A) base sta-tion (eNodeB, eNB) comprises a controller 606 operationally connected to a memory 607, and a transceiver 608. The controller 606 controls the operation of the radio network node 601. The memory 707 is configured to store software and data. The transceiver 608 is configured to set up and maintain a wireless connection to the user equipment 502 within the service area of the radio network node 501. The transceiver 608 is operationally connected to an antenna arrangement 609. The antenna arrangement 609 may comprise a set of antennas. The number of antennas may be two to four, for example. The number of antennas is not limited to any particular number. The radio network node 501 may be operationally connected (directly or indirectly) to another network element of the communication system, such as a further radio network node, radio network controller (RNC), a mobility management entity (MME), an MSC server (MSS), a mobile switching centre (MSC), a radio resource management (RRM) node, a gateway GPRS support node, an operations, administrations and maintenance (OAM) node, a home location register (HLR), a visitor location register (VLR), a serving GPRS support node, a gateway, and/or a server, via an interface (not shown in FIG. 6). The embodiments are not, however, restricted to the network given above as an example, but a person skilled in the art may apply the solution to other communication networks provided with the necessary properties. For example, the connections between different network elements may be realized with internet protocol (IP) connections.

Although the apparatus 501, 502 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, and a line telephone.

The apparatus 501, 502 may generally include a processor, controller, control unit or the like connected to a memory and to various interfaces of the apparatus. Generally the processor is a central processing unit, but the processor may be an additional operation processor. The processor may com-prise a computer processor, application-specific integrated circuit (ASIC), field-programmable gate array (FPGA), and/or other hardware components that have been programmed in such a way to carry out one or more functions of an embodiment.

The memory 602, 607 may include volatile and/or non-volatile memory and typically stores content, data, or the like. For example, the memory 602, 607 may store computer program code such as software applications (for example for the detector unit and/or for the adjuster unit) or operating systems, information, data, content, or the like for a processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

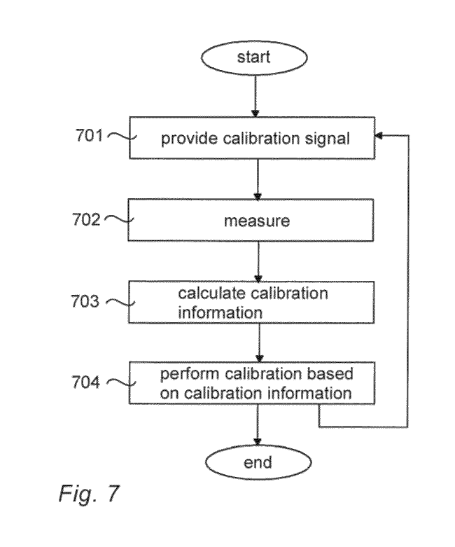

FIG. 7 is a flow chart illustrating an exemplary embodiment. An apparatus which may comprise e.g. an apparatus implemented in a transmitter unit (transmitter module) as described above in connection with FIGS. 1 to 4, may, in item 701, create an uplink calibration signal for active antenna or antenna array uplink calibration, at a baseband part of the transmitter directly to a selected duplex spacing or another specified spacing from a transmission signal inside a BB Tx output sampling rate band of the transmitter. In item 702, the apparatus may carry out measurements between different antenna combinations inside the antenna array. The apparatus may measure a strength of a radio frequency signal (i.e. the calibration signal). The strength may be measured as a power or as an absolute amplitude of the calibration signal. For example, based on a calibration signal correlation used, phase, delay and amplitude information may be measured in item 702. In item 703, based on collected measurement data, the apparatus may calculate calibration information for each measurement branch of the antenna array by using a mathematical formula (e.g. a formula based on a linear simultaneous equation). In item 704, the apparatus may perform active antenna array beam calibration based on the calculated calibration information. Thus, for a Tx signal path, the apparatus may be configured to a) transmit 701, from one antenna in the active antenna array, a Tx calibration signal, b) receive 702, 703, 704, in the other antennas in the active antenna array, the Tx calibration signal, and repeat a) and b) until each (or predefined) antenna combination(s) in the active antenna array are calibrated.

An exemplary embodiment may be implemented as a computer program comprising instructions for executing a computer process for active antenna array beam calibration. The computer program may be stored on a computer program distribution medium readable by a computer or a processor. The computer program medium may be, for example but not limited to, an electric, magnetic, optical, infrared or semiconductor system, device or trans-mission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

The steps/points, signalling messages and related functions de-scribed above in FIGS. 1 to 7 are in no absolute chronological order, and some of the steps/points may be performed simultaneously or in an order differing from the given one. Other functions can also be executed between the steps/points or within the steps/points and other signalling messages sent be-tween the illustrated messages. Some of the steps/points or part of the steps/points can also be left out or replaced by a corresponding step/point or part of the step/point. The apparatus operations illustrate a procedure that may be implemented in one or more physical or logical entities. The signalling messages are only exemplary and may even comprise several separate messages for transmitting the same information. In addition, the messages may also contain other information.

Thus, there is provided a method where a required signal spectrum may be generated with required frequency separation, amplitude and information anywhere inside the BB Tx branch sampling rate spectrum.

Further, there is provided active antenna or antenna array uplink calibration. An uplink calibration signal spectrum is generated inside the BB Tx branch sampling rate spectrum to Tx DAC. The Tx DAC sampling rate and, depending on the configuration, the Tx feedback linearization chain support the required Tx transmission and uplink calibration spectrums frequency separations BW. This technique makes it possible to have runtime calibration without disturbance or cancel the Tx transmission during uplink calibration.

Yet further, there is provided active antenna or antenna array Tx and Rx band signal monitoring and self active diagnostics. With this technique, it is possible to create needed monitoring or a self diagnostic signal using the BB Tx signal branch. The required signal or signals is/are possible to be created anywhere inside the Tx branch BB sampling rate spectrum to the Tx DAC.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

ADC analogue-to-digital converter
DAC digital-to-analogue converter
Rx receiver
Tx transmitter
TRX transmitter-receiver (transceiver)
PA power amplifier
SW switch
LNA low noise amplifier
MIX mixer
MIMO multiple input multiple output
DPD digital predistortion
BB baseband
BW bandwidth
AMP amplifier
MOD modulator
Cal SIG calibration signal
FB feedback
RF radio frequency
HW hardware
DL downlink
DC direct current

1. A method for antenna calibration in communications, characterized by
creating an uplink calibration signal for active antenna or antenna array uplink calibration, at a baseband part of a transmitter directly to a selected duplex spacing or another specified spacing from a transmission signal inside a baseband output sampling rate spectrum of the transmitter;
carrying out measurements on the uplink calibration signal;
based on collected measurement data, calculating calibration information;
performing the active antenna or antenna array uplink calibration based on the calculated calibration information;
the uplink calibration signal having its own spectrum separated from a transmission spectrum, an uplink calibration spectrum is provided that is readable from transmitter modulator output by using a directional coupler or a radio frequency probe.

2. A method according to claim 1, characterized by performing the active antenna or antenna array uplink calibration without interrupting the transmission of the transmitter.

3. A method according to claim 1, characterized in that the uplink calibration signal and the transmission signal of the transmitter are both present at a baseband output spectrum of the transmitter after a modulator mixer of the transmitter.

4. A method according to claim 1, characterized in that the uplink calibration signal and the transmission signal of the transmitter are both present at a baseband output spectrum of the transmitter after a direct radio frequency sampling digital-to-analogue converter of the transmitter.

5. A method according to claim 1, characterized in that the uplink calibration signal is separated from the transmission signal by a required separation, wherein the separation comprises a transmitter-to-receiver duplex separation or other separation.

6. (canceled)

7. A method according to claim 1, characterized in that the uplink calibration signal has its own spectrum separated from a transmission spectrum, without a calibration code being passed to a power amplifier at a transmission frequency.

8. A method according to claim 1, characterized in that the uplink calibration signal is passed to a power amplifier without being passed to a front-end transmitter filter.

9. A method according to claim 1, characterized in that a transmitter baseband output signal sampling rate bandwidth to a digital-to-analogue converter of the transmitter and a power amplifier linearization bandwidth are wide enough in order to provide a required separation between the transmission signal and the uplink calibration signal.

10. A method according to claim 1, characterized in that the uplink calibration signal is passed through transmitter predistortion band filtering.

11. A method according to claim 1, characterized in that the uplink calibration signal is created inside the transmitter predistortion band without rejecting the uplink calibration signal at linearization.

12. A method according to claim 1, characterized in that the uplink calibration signal level is low enough at the baseband so that the uplink calibration signal is not passed on the air.

13. A method according to claim 1, characterized in that the uplink calibration signal is taken from one or more transmitter branches by using directional couplers or radio frequency probes.

14. A method according to claim 1, characterized in that a mixer is used to shift an output frequency of the transmitter to a required frequency, wherein the uplink calibration signal is generated to a required spacing from the transmission signal at the baseband part.

15. A method according to claim 1, characterized in that the uplink calibration signal and the transmission signal are generated directly to a required transmitter-to-receiver duplex spacing at the baseband part, without using a mixer.

16. An apparatus comprising an arrangement for coupling an antenna, and a transmitter operationally coupled to the antenna, characterized in that the transmitter is configured to
create an uplink calibration signal for active antenna or antenna array uplink calibration, at a baseband part of a transmitter directly to a selected duplex spacing or another specified spacing from a transmission signal inside a transmitter baseband branch sampling rate spectrum to a digital-to-analogue converter of the transmitter;
carry out measurements on the uplink calibration signal;
based on collected measurement data, calculate calibration information;
perform the active antenna or antenna array uplink calibration based on the calculated calibration information;
the uplink calibration signal having its own spectrum separated from a transmission spectrum, an uplink calibration spectrum is provided that is readable from transmitter modulator output by using a directional coupler or a radio frequency probe.

17. (canceled)

18. A computer program product, characterized by comprising program code means configured to perform the method steps of claim 1 when the program is run on a computer.

19. A computer-readable storage medium, characterized by comprising program code means configured to perform the method steps of claim 1 when executed on a computer.

20. A transmitter, characterized in that it comprises an apparatus according to claim 16.

21. A network element, characterized in that it comprises a transmitter of claim 20.
